(19) United States
(12) Patent Application Publication
(10) Pub. No.: US 2006/0110523 A1
(43) Pub. Date: May 25, 2006

(54) Processed tomato products and process for preparing the same

(76) Inventors: Anthony John Barraclough, Bedford (GB); Nancy Sue Blaker, Stockton, CA (US); Steven Peter Colliver, Sharnbrook (GB); Adel El Sheikh, Stockton, CA (US); Michael John Gidley, Sharnbrook (GB); Jinguo Hu, Stockton, CA (US); John Turner Mitchell, Sharnbrook (GB); Jacqueline De Silva, Sharnbrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/523,486

(22) PCT Filed: Aug. 4, 2003
(86) PCT No.: PCT/EP03/08645

§ 371 Date: Oct. 20, 2005

(30) Foreign Application Priority Data
Aug. 8, 2002 (EP) 02255556.9

(51) Int. Cl. A23L 1/212

(52) U.S. Cl. 426/615

(57) ABSTRACT

Processed tomato products which have an increased consistency as expressed by reduced Bostwick at certain insoluble solids level and Brix value.

### FIELD OF THE INVENTION

The present invention relates to processed tomato products and a process for preparing tomato products.

### BACKGROUND OF THE INVENTION

In the industry of processing tomatoes to end products like sauces, ketchups, soups, toppings, etcetera usually two stages are distinguished: primary processing and secondary processing. Primary processing usually involves at least either hot- or cold breaking of the tomatoes and a concentration step. In the concentration step water is removed from the tomato pulp, so as to obtain a thick paste. The water removal can be done by many ways, although evaporative removal of water (by heating) is the common method. The so-obtained thickened paste or puree can be stored or directly further processed into a range of finished products such as tomato sauce for pasta, tomato ketchup, etcetera.

Such end products generally need a specific thickness to be valued as quality products (next to a good colour, flavour, etcetera). In order to achieve this, it is preferred that the product has (at a given percentage of soluble solids) a high consistency. Consistency in the tomato industry is often measured and expressed as Bostwick value. In the handbook “Tomato Production, Processing & Technology” (3^{rd} ed.) by W. A. Gould, CTI Publications, Timonium, Md., USA it is set out on page 329, 330 how Bostwick measurements on tomato purees and pastes is usually performed in the tomato processing industry and tomato research.

In part, the thickness is determined by the amount of insoluble solids present per unit of tomato product. The insoluble solids are in part cellulose, pectins and other compounds that make up the structural matrix of the fruit. The amount of insolubles may vary per variety, season, growth stage, etcetera. The degree of concentration of tomato products is usually expressed in degrees Brix and is an indication of the amount of soluble solids in a tomato (product). To exemplify this: a tomato paste of 20 Brix is considered to be twice as much concentrated as a paste of 10 Brix of the same tomatoes.

Of course, in order to achieve thick products one can highly concentrate the tomato puree. The result will be a product with a high degree of Brix, a firm consistency (expressed by low Bostwick value). However, this is costly, as many kilograms of tomatoes are needed to produce one kilogram of tomato product, and the evaporative concentration is also a cost factor. Furthermore, flavour and colour can be adversely affected by rigorous concentration, e.g. due to burning in the evaporators.

Many techniques have been developed to thicken paste without changing Brix value. Such methods include treating of the pectic substances with enzymes, adding thickeners, etcetera. These methods all have their disadvantages.

Hence, there is a need for tomato paste having a firm consistency at a reasonable Brix value. Also, there is a need for processed tomato products other than tomato paste (in the strict sense of the word) which have an increased consistency. Furthermore, such tomato paste should have an acceptable flavour and colour for a tomato paste. Apart from paste as described above, there is also a need for processed tomato products containing pulp or dices of tomato products having a good firmness and improved pulpiness, and manufacturing of such pulp or dices and processed tomato products containing such pulp or dices should be convenient (e.g. with low losses/size reduction due to pulp and/or dices being disintegrated or reduced in size due to attrition in the production chain.

Tomatoes having impaired ripening are reported, e.g. due to specific mutations known as alc, nor, rin and Nr.

E. Kopeliovitch et al, Euphytica 28, 99-104 (1979) disclose improved storage life for ripening inhibited mutants rin, nor, Nr. Pigmentation is also discussed.

E. Kopeliovitsch et al, J. Amer. Soc. Hort. Sci. 107(3), 361-364 (1982) disclose the effect of genes rin and nor on the flavour of raw tomatoes. It is mentioned that fruits homozygous in rin or nor are inferior to other fruits as to their fruity flavour.

E. C. Tichelaar et al, CSIRO Fd Res. Q, 38, 22-24 (1978) disclose tomato fruit ripening, and more in particular in the influence of the nor gene on that.

E. C. Tichelaar et al, HortScience, 13(5), 508-513 (1978) disclose enzyme levels, color, shelf life and other characteristics of homozygous and heterozygous Nr, rin and nor tomatoes.

R. W. Buescher et al, J. Food Science, 44(1), 190-192 (1979) disclose characteristics of processed tomato products of heterozygous nor fruit (nor hybrid with Heinz variety H1439).

S. Malis-Arad et al, J. Hort. Science, 58(1), 111-116 (1983) disclose measurement of pectic substances in rin and nor tomatoes.

K. Davies et al, J. Plant Physiol. 139, 140-145 (1991) disclose influence of salt stress on ripening of nor tomato fruit.

M. L. de Araujo et al, Euphytica 125, 215-226 disclose analysis of homozygous and heterozygous alc tomatoes in combination with color genes ogc and hp. These fruit were generated with the view to achieving normal fruit color and extended shelf life.

M. Mutschler et al, J. Amer. Soc. Hort. Sci., 109(4), 504-507 (1984) disclose ripening and storage characteristics of the alc tomato.

G. E. Hobson, J. Sci. Food Agric. 31, 578-584 (1980) discloses the effect of Nr and rin genes on the composition, enzyme content and potential use of such tomatoes.

Although from the above references it seems a range of properties of such ripening-inhibited tomatoes due to one or more genes of alc, rin, nor or Nr have been studied, commercial use was not reported, and in fact discouraged.

### SUMMARY OF THE INVENTION

It has now been found that the above objectives may be achieved (at least in part) by a tomato paste having an increased consistency such that when measured at an insoluble solids interval of 2.5-3.6% at 12° Brix:
(Bostwick value)<10.5−2.3822×(percentage of insoluble solids), (1)
when Bostwick is measured as defined in the reference given above.

Preferably, this is achieved by a tomato paste having an increased consistency such that when measured at an insoluble solids interval of 2.5-3.6% at 12° Brix:
(Bostwick value)<10.0−2.3822×(percentage of insoluble solids). (2)

Most preferably, this is achieved by a tomato paste having an increased consistency such that when measured at an insoluble solids interval of 2.5-3.6% at 12° Brix:
(Bostwick value)<9.5−2.3822×(percentage of insoluble solids). (3)

As is stated above, the tomato paste when measured should have an insoluble solids level of 2.5-3.6%, and at 12° Brix. Pastes with different levels of Brix are also part of the invention, but need to be concentrated/diluted before measurement. In the above, the Bostwick value will suitably be above 0.1 at said Brix level.

Tomato paste is herein to be understood as a commercially-processed (or factory-processed) tomato paste as it is known in the art of tomato processing. Such tomato paste is the result of primary processing tomatoes (comminution/heating and concentrating by removal of water) as is done shortly after harvesting. A hot break process is preferred for optimal consistency. The resulting product is a concentrated paste, which can be stored until further use, or can be sold. There are commercial producers of such tomato paste (product). For comparison and measuring, such paste should be free of added thickeners, such as starches or gums. Also, for comparison and measuring, the pastes should not have been subjected to additional processing steps that may increase the consistency, such as homogenisation treatment. Conventional, commercially available paste is free of such additional thickeners or process steps.

Although for measuring the Bostwick value at 12° Brix as set out above the tomato paste is a paste obtained with a hot break process, without additional process steps or ingredients that influence the consistency, the invention may be applied to all sorts of tomato paste (hot and cold break), which do comprise additional thickeners or process steps that influence the consistency.

Of a commercially available paste one can measure Bostwick, Brix, and insoluble solids, and such numbers can give an indication of the quality of the paste.

Tomato paste can be obtained by a hot break process (comminuting and heating to approx. 80° C.), optionally followed by a concentration step to bring it to the required Brix value. Such concentration (i.e. water-removal) will usually be done by evaporation. The tomato paste according to the invention does not contain gums, starches, or other thickeners when measuring Bostwick and Brix value. Bostwick is usually measured at 12° Brix. If the tomato paste has a too high Brix value, dilution with water to the required value of 12° may be applied.

The tomato paste according to the invention preferably is red (reddish), yellow (yellowish), orange (orangish), or pink (pinkish). Preferably, the paste according to the invention has a USDA color score at 8.5° Brix of 35-60. Dilution may be needed to measure at the required Brix value.

There are factories (“secondary processing”) that buy/use tomato paste for preparing processed tomato products, such as pasta sauce, juice, ketchup, etcetera. Such processed tomato products may also be prepared from tomato paste, or from fresh tomatoes. Following this, apart from a tomato paste with an increased consistency, there is also a desire for processed tomato products with a good consistency.

One factor which limits the consistency that can be obtained from processed tomato products is the softening of fruit that takes place as part of the ripening process. Aspects of fruit ripening such as development of colour and flavour give rise to desirable characteristics in processed tomato products. It would be advantageous to combine the high consistency of unripe fruit with the colour and/or flavour of ripe fruit in a processed tomato product.

A number of genes are involved in controlling the process of tomato fruit ripening. Mutations in such genes can lead to ripening-inhibited fruit in which all aspects of the ripening process, such as softening, red colour formation, and flavour development are inhibited. If the mutation is present in homozygous form, softening is minimised, and development of both colour and flavour is severely restricted. Examples of gene mutations that result in ripening-inhibition in tomatoes include ‘alcobaca’ (alc), ‘ripening-inhibited’ (rin), ‘non-ripening’ (nor), and ‘Never ripe’ (Nr).

It has been found that both tomato paste and processed tomato products with a good consistency can suitably be achieved if tomatoes homozygous in alc, rin, nor, or Nr are used to prepare a tomato paste or processed tomato product. Hence, the invention further pertains to a paste or product comprising tomatoes which are homozygous for alc, homozygous for rin, homozygous for nor, homozygous for Nr, heterozygous for combinations of (at least) two of the alc, rin, nor or Nr genes, or combinations thereof. Such tomatoes are herein after referred to as “tomatoes according to the invention”.

In a preferred aspect of the invention, the paste or product is prepared by using tomatoes according to the invention and which in addition comprise color enhancing genes such as old gold crimson (ogc), high pigment (hp), dark green (dg), intense pigment (Ip), or other color enhancing transgenic genes. Such tomatoes can not only be used to make tomato paste but can be used for a whole range of processed tomato products. The term “processed tomato product” is herein to be understood as to comprise any product that comprises tomatoes which are subjected to processing steps (in any order) such as heating and breaking and optionally concentrating and packing. Examples of processed tomato products are: tomato pastes, tomato sauces, tomato juices, tomato concentrates, tomato passatas, salsa, barbecue sauce, pizza sauce, spaghetti sauce, tomato fritto, ketchup (catsup), soup or other form.

As a result of the invention, it is possible to take advantage of the outstanding paste and serum viscosity of tomatoes which are homozygous for the alc genes without sacrificing desirable tomato color characteristics which are of importance to consumers. Also, the paste and serum of the tomatoes enjoy excellent resistance to syneresis. It is likewise believed that homozygous rin tomatoes, homozygous nor tomatoes, homozygous Nr tomatoes, or heterozygous alc/rin, alc/nor, alc/Nr, rin/nor, Nr/nor, rin/Nr tomatoes can be advantageously used in the present invention.

The tomato paste according to the invention preferably has at 12° Brix Bostwick thickness values in the range of from 0-3 cm, preferably from 0-2 cm. Likewise preferred tomato pastes according to the invention enjoy at 12° Brix syneresis levels of less than 4 mm, preferably less than 3 mm. This is in contrast to Bostwick values of 4.5-7 cm and syneresis values of 13-25 mm for, e.g., the BOS 3155 variety (industry-known variety).

The invention may provide processed tomato products having both good color and outstanding thickness, without requiring the mixing of different types of tomatoes. Preferably the pastes according to the invention have a red (reddish), yellow (yellowish), orange (orangish), or pink (pinkish) color. More preferably, the pastes of the invention have a USDA color score at 8.5° Brix of at least 35, especially greater than 42. Preferably, said color scores are below 60. USDA scores are standardised measurements for color quality.

We have found that it is possible to produce a tomato having both homozygous (what is believed to be) alc and the old gold crimson (ogc) genes, wherein the tomato color is good, yet at the same time tomato fruit firmness and juice and paste viscosity are excellent as a result of the ripening inhibiting effect of the alc gene.

Following the above, the present invention relates to processed tomato products such as tomato pastes, tomato sauces, tomato juices, tomato concentrates, tomato passatas, salsa, barbecue sauce, pizza sauce, spaghetti sauce, tomato fritto, ketchup (catsup), soup, pulp, dices (including products containing pulp and dices) and others, which processed tomato products comprise tomatoes according to the invention. Preferably, the above products are prepared of tomatoes which further include color enhancing genes as well. Processed tomato products preferably have a Brix value of 5-31°, preferably (depending upon the intended use) of 10-25°. Also depending upon the use they may contain 0.1-5% wt, preferably 0.5-3% wt of salt, most preferably 1-2% wt. The pH may suitably be between 3 and 5, preferably between 4.0 and 4.4.

Preferably, the invention concerns processed tomato products made from populations or assemblages of the above fruits having an average of at least 10% by weight, and preferably at least 25%, more preferably at least 50% of the tomatoes with the above-described genes. The tomatoes for such processed tomato products may be obtained through classical breeding and selecting, but may also be obtained by genetic modification, as is set out in WO 01/04315 and WO 01/14561.

The pastes of the invention preferably include at least 50% by weight of the tomatoes according to the invention, especially from 50 to 100% by weight. Juices preferably include at least 10% by weight of the tomatoes according to the invention, especially from 20 to 40% by weight.

Preferably, the tomatoes according to the invention are homozygous for the color enhancing gene such as ogc, hp or dg.

Use of the tomatoes according to the invention is particularly beneficial in view of their unique qualities, such as extremely high viscosity and almost no syneresis. It is believed these advantages are not achieved with tomatoes or tomato pastes outside of our invention (when measured with equivalent soluble solids level and absence of other thickening material, such as starch, gums, etcetera). A secondary benefit is that as a result of such characteristics, less paste can be used in preparing a sauce. The advantageous paste characteristics according to the invention can be expected to translate to improved, consumer perceivable characteristics for processed tomato products, such as improved mouthfeel and texture and to lead to more full-bodied sauces and other products.

### DETAILED DESCRIPTION OF THE INVENTION

Although it is believed tomatoes as such are known which are homozygous in rin, alc, or one or more other ripening-inhibiting genes mentioned, it is believed such tomatoes have never been used in tomato processing, and in fact it is reported that commercial use would not be suitable. Also, the tomatoes homozygous in rin, alc, or other genes that have been studied usually referred to tomatoes that do not form color. Hence, (industrially) processed tomato products (and tomato paste) having the properties as described above are novel, and in particular such processed tomato products that have a red or reddish color (e.g. USDA color score of at least 35, optionally less than 60). Furthermore, it is quite surprising that processed tomato products of good quality in terms of consistency and color could be achieved having the properties as now claimed, as tomatoes that are firm are usually associated with green, unripe tomatoes. Unripe, green tomatoes are unsuitable to use in large quantities in conventional tomato products, following the color and the flavour profile which is different from ripe tomatoes.

Without wishing to be bound by theory, it is believed that tomatoes according to the invention are different from conventional tomatoes in that such gene mutations are not present in conventional tomatoes. When such gene mutations are present in heterozygous, or more preferably in homozygous form, they may interrupt part of the ripening process. It is believed that tomatoes according to the invention have different cell walls, e.g. more dense cell walls.

It has been found that a tomato believed to be homozygous in alc has levels of certain enzymes which are different from conventional tomatoes. It was found that such a tomato, also comprising a color gene such as ogc, had similar levels of exogalactanase when green as a conventional tomato. This is not surprising, but several days post breaker (i.e. when pinkish/orange/red) the level of exogalactanase stayed low for (what was believed to be) an alc/ogc tomato, whereas for conventional tomato this level increases substantially. Regarding polygalacturonase similar findings were obtained. Processing such tomatoes into processed tomato products has distinct advantages. Still, thanks to the color gene ogc, such tomato has good color. Although a process may involve processing only such tomatoes, it may be preferred to use a blend of tomatoes: conventional tomatoes (for economic reasons) with tomatoes according to the invention. Preferably, such tomatoes according to the invention should also have one or more of the color genes as set out hereinbefore.

Hence, the present invention also relates to a process for preparing a tomato product, the product being red (reddish), yellow (yellowish), orange (orangish), or pink (pinkish) and wherein at least 10% (pref. at least 20%, more pref. at least 50%, up to 100%) of the tomatoes to be processed have a level of polygalacturonase of less than 200 (preferably less than 100, more pref. less than 50, usually more than 1) μmoles GalA/ml/hour, and wherein said tomatoes to be processed have a level of exogalactanase of less than 70 (preferably less than 50, most preferably less than 35, usually more than 0.1) nmoles galactose/g fwt/hour (fwt=fresh weight). More preferably the product has a USDA color score of 35-60 and wherein at least 10% (pref. at least 20%, more pref. at least 50%, up to 100%) of the tomatoes to be processed have a level of polygalacturonase of less than 200 (preferably less than 100, more pref. less than 50, usually more than 1) μmoles GalA/ml/hour, and wherein said tomatoes to be processed have a level of exogalactanase of less than 70 (preferably less than 50, most preferably less than 35, usually more than 0.1) nmoles galactose/g fwt/hour (fwt=fresh weight). In this, it is preferred that at least 10% (pref. 20%, more pref. 50%) of the tomatoes to be processed are homozygous for rin, homozygous for nor, homozygous for Nr, homozygous for alc, heterozygous for combinations of two of the rin, nor, Nr or alc genes, or combinations thereof. It may also be preferred that the tomatoes are homozygous for at least two of rin, nor, Nr, or alc.

As (depending on amount used, and desired end product) it may be preferred that the resulting product has some color, it is preferred that the tomatoes as used in the process as set out above further comprise at least one color enhancing gene. For example, said color enhancing genes may be selected from the group consisting of old gold crimson (ogc), high pigment (hp), dark green (dg), intense pigment (Ip), as well as color enhancing transgenic genes.

The invention further relates to a tomato which was found by the present inventors on which is believed to be alc, and has a specific 180 bp fragment following PCR amplification and Taq1 restriction of genomic DNA of said tomato (see example 5). Said tomato was following crossing with ogc tomatoes ripening inhibited, but not green. Hence, the invention further relates to red, orange, yellow or pink tomato showing a 180 bp fragment following PCR amplification and Taq1 restriction of genomic DNA of said tomato, as well as to a food product containing at least 10% wt of such tomato. It was found that such tomato was suitable for preparing paste, tomato pulp, and tomato dices, and hence the invention also relates to a tomato paste, tomato pulp, tomato dices comprising at least 10% wt (preferably at least 20% wt) of such tomatoes. The invention further relates to processes as disclosed herein wherein the tomatoes to be processed comprise at least 10%, preferably at least 20% wt of a red, orange, yellow or pink tomato showing a 180 bp fragment following PCR amplification and Taq1 restriction of genomic DNA of said tomato.

Conventional tomatoes are usually processed into paste using either a cold-break process or a hot-break process. The hot-break process involves heating to above about 80° C. and comminuting (‘breaking’) the tomatoes, whereas a cold break would be heating to below about 80° C. and comminuting (‘breaking’) the tomatoes. The hot break process has as advantage that endogenous enzymes are inactivated quickly, including pectin-degrading enzymes like exogalactanase and polygalacturonase. Such a product (e.g. paste) with substantial amount of long pectin-chains may have good consistency. The disadvantages are that heating may involve damage to the flavour: a cooked or burnt aroma may develop, losing volatiles and/or fruity flavours. The cold-break process does not de-activate the pectin-degrading enzymes quickly, so some degradation of pectin may occur, resulting in a paste with less consistency. On the other hand, the flavour is usually better of a cold break product. For these reasons, mixtures of cold- and hot break products may be used.

Following the low level of pectin-degrading enzymes (polygalacturonase and exogalactanase) of the tomatoes according to the invention, such tomatoes may be processed using a so-called ‘cold break process’ and have consistency more similar to hot break products, as it is believed by nature less pectin-degrading enzymes are present in the tomatoes according to the invention, and hence even if they are processed into paste using a cold-break process such tomato paste may contain a substantial amount of pectin. Thus, the invention also relates to a process comprising the steps of:

heating tomatoes to a temperature of 60-120° C. (preferably 60-80° C.),

size reduction (e.g. comminution) of said tomatoes

in any given order (optionally followed by concentration).

The tomato pastes and processed tomato products may be prepared using conventional processing techniques.

As the tomatoes according to the invention are low in certain enzymes, the invention further relates to a process for preparing a tomato product (e.g. paste or any other product) in which tomatoes are used which are low in polygalacturonase and/or exogalactanase.

Hence, the invention further relates to a process for preparing a tomato product, the product having a USDA color score of 35-60(i.e. red) and wherein at least 10% (pref. at least 20%, more pref. at least 50%, up to 100%) of the tomatoes to be processed have a level of polygalacturonase of less than 200 (preferably less than 100, more pref. less than 50, usually more than 1) μmoles GalA/ml/hour, and wherein said tomatoes to be processed have a level of exogalactanase of less than 70 (preferably less than 50, most preferably less than 35, usually more than 0.1) nmoles galactose/g fwt/hour.

In the above, it is preferred that at least 10% (pref. at least 20%, more pref. at least 50%, up to 100%) of the tomatoes to be processed are homozygous for rin, homozygous for nor, homozygous for Nr, homozygous for alc, heterozygous for combinations of two of the rin, nor, Nr or alc genes, or combinations thereof.

The invention also relates to a process and product (i.e. tomato paste and other processed tomato product) in which other ripening-inhibiting genes than alc, rin, nor, Nr, are present in the tomato in such a genotypic form that they inhibit ripening similar to the tomatoes as are herein disclosed. This may relate to genes not yet known to inhibit ripening, alone or in combination.

It is preferred that the tomatoes as used in the process as set out above (e.g. to prepare a processed tomato product) further comprise at least one color enhancing gene. For example, such color enhancing genes are selected from the group consisting of old gold crimson (ogc), high pigment (hp), dark green (dg), intense pigment (Ip), as well as color enhancing transgenic genes.

The invention further relates to a process as set out above, wherein the process comprises the steps of:

heating tomatoes to a temperature of 60-120° C.,

comminuting or dicing said tomatoes

in any given order. More preferred in the above heating step is a temperature of 60-80° C. Optionally, a concentration step may be applied, e.g. by water-removal, e.g. by evaporation.

### EXAMPLES

In the experiments below, the following methods were followed.

Brix

A digital refractometer (Bellingham Stanley RFM 342 digital refractometer) thermostatically controlled at 20° C. was used. The refractometer was calibrated with a range of 1-30% w/w sucrose in de-ionised water as standard solutions. Enough tomato product was weighed into centrifuge tubes to provide a 1-2 ml liquid layer after centrifugation and centrifuged in a high speed centrifuge at 20° C., using a Beckman Optima TLX ultracentrifuge (TLA100.4 8-position fixed angle rotor) having the following gradient: 5,000/2 min., 20,000/2 min., 75,000/4 min., 100,000/10 min., 50,000/1 min., end) at 95,000 RPM +/−5,000 RPM for 5 minutes to separate liquid from solid. The centrifugate liquid was placed in a small vial and mixed gently. The liquid was placed on the optic of a thermostatted refractometer, the lid closed and measured after the sample had sat for 30 seconds to reach the required temperature. The average of triplicate readings was calculated.

Bostwick

Bostwick measurement was performed on a 25 cm Bostwick levelled in two directions. Paste was diluted to 12° Brix and warmed or cooled to 20° C. Sample was placed in the Bostwick to the top of the sample chamber and the trap door opened.

Degree of flow was determined after 30 seconds.

Samples were each tested in duplicate.

Insoluble Solids

Tomato paste was sourced from around the world including Unilever factories in Chile (Malloa), California (Stockton/Merced), India and Australia (Tatura) and external sources (Conesa, ARC, Copais). These were used to construct a calibration line for tomato paste at 12 Brix.

A 1-1.5 g sample of juice was weighed out to 4 decimal places between 4 pre-weighed filters (Whatman GFA 5.5 cm diameter). This was then placed on a Buchner vacuum filtration system and washed with 6 litres of de-ionised water. The filters were then dried in a vacuum oven at 70° C. for 1.5 hours and then cooled in a dessicator to room temperature. The filters were then re-weighed and insoluble solids calculated as the final weight minus initial filter weight, divided by the initial juice weight minus filter weight. Determination was carried out in triplicate.
% insolubles=(weight of dried sample+filter)−filter/sample weight*100

Also, the dilution factor from paste to 5° Brix juice as above was taken into account by separate multiplying.

### Example 1

### Breeding and Selection

As starting material a cross between a homozygous ripening-inhibited mutant (thought to be alc; see example 5 for indentification) and a homozygous old gold crimson (ogc) mutant was obtained from Ohio State University, USA (accession number 96-9422-400). This population of F1 heterozygous alc/ogc was then selfed, and single plants selected that had the phenotypical characteristics of both fruit ripening-inhibition (homozygous alc) and golden flower colour (homozygous ogc). Seed from selected plants was then back-crossed with in-house breeding lines to produce stable double homozygous plants, for evaluation of fruit and processed tomato product characteristics.

### Example 2

### Bostwick vs. Insoluble Solids: 22 Conventional Pastes (Control) and According to Invention

Of 22 hot and cold break tomato pastes from factories or commercially available the percentage of insoluble solids was measured, and the Bostwick value was determined (all at 12° Brix). The Bostwick values (averages of various measurements per paste) were then plotted against percentage of insoluble solids.

The hot break pastes were either commercially available products, or were prepared in own factories using the following process: the tomatoes are crushed with a minimum of air inclusion and quickly heated to greater than 85° C. typically through contact with a steam coil. The juice is then extracted and evaporated typically by a 2 or 3 stage process to between 24° and 31° Brix. For measuring, the samples were diluted to 12° Brix.

The cold break pastes were commercially available products, and are typically prepared by crushing the tomatoes at temperatures of less than 85° C. with a minimum of air inclusion. The juice is then extracted and evaporated by typically a 2 or 3 stage process to between 24 and 31° Brix. For measuring, the samples were diluted to 12° Brix.

The percentage insoluble solids was calculated as described earlier. The Bostwick value was determined using the method as described earlier. The results of these measurements are in table 1.

TABLE 1
insoluble solids and Bostwick of 22 commercially available pastes

| Insoluble solids | Bostwick |
|---|---|
| 1.756 | 7.6 |
| 2.0545 | 6.75 |
| 2.062 | 6.4 |
| 2.0845 | 6.6 |
| 2.162 | 6.3 |
| 2.217 | 5.8 |
| 2.353 | 5.8 |
| 2.368 | 5.5 |
| 2.413 | 5.5 |
| 2.568⁽¹⁾ | 5.1 |
| 2.6515 | 5 |
| 2.674 | 4.9 |
| 2.678 | 4.2 |
| 2.7415 | 4.75 |
| 2.95⁽²⁾ | 4.5 |
| 2.974 | 4 |
| 2.98⁽³⁾ | 4.3 |
| 3.07 | 4.1 |
| 3.139 | 3.25 |
| 3.38 | 3.2 |
| 3.38 | 3.25 |
| 3.6⁽⁴⁾ | 2.7 |

Source of some of the pastes:
⁽¹⁾Chilean Malloa
⁽²⁾Unilever Van den Bergh's
⁽³⁾CONESA
⁽⁴⁾COPAIS

Two trial harvests of alc-ogc tomatoes (according to the invention) were processed and Bostwick/insolubles measured in the same manner, with results:

| Insoluble solids | Bostwick |
|---|---|
| 3.3 | 0.9 |
| 3.6 | 0.5 |

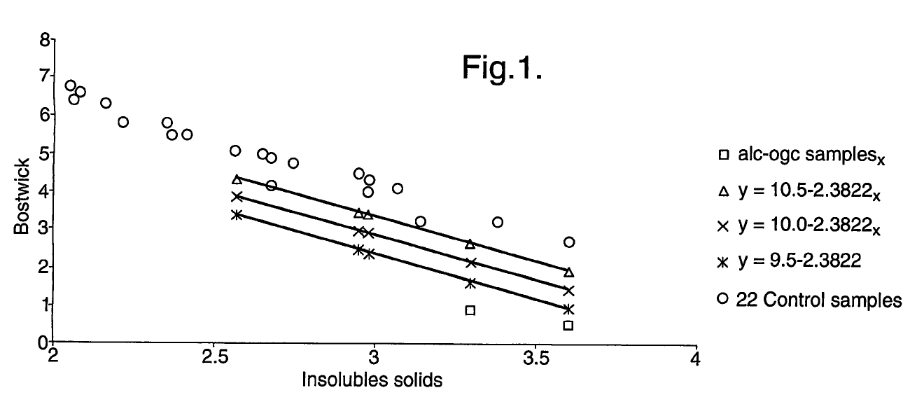

The results are set out graphically together with the results of table 1 in FIG. 1. FIG. 1 also gives lines for the equations:
(Bostwick value)=10.5−2.3822×(percentage of insoluble solids) (1)
(Bostwick value)=10.0−2.3822×(percentage of insoluble solids) (2)
(Bostwick value)=9.5−2.3822×(percentage of insoluble solids) (3)

As can be seen, all conventional pastes tested have a Bostwick value larger than equation (1) above would give, at the insoluble solids interval of 2.5-3.6%.

### Example 3

### Exogalactanase Activity

Exogalactanase activity of four types of tomatoes were measured at three stages of maturity: in the green stage (i.e. well before breaker point), 5-6 days post breaker, and 12-13 days post breaker. The four types tomatoes were: the tomato according to example 1, which is thought to be homozygous for alc and homozygous for ogc, Bos 3155 (as commercially available) U338 (internal breeding line with conventional ripening and color) and homozygous ogc (internal breeding line with conventional ripening).

The exogalactanase activity was expressed as nmoles galactose per gram fresh weight (fwt) per hour that could be converted. The galactose conversion was measured using the following protocol.

Preparation of Extracts

Samples of tomato pericarp were taken from the frozen storage and placed in a 50 ml Falcon tube containing PVPP (1% w/v buffer). 1:1.5 (w:v) of 0.2M NaPhosphate buffer pH7.5 was then added. This was left for 60 mins at 4° C. for the fruit to defrost slightly to allow a more uniform homogenisation. A Polytron SEV was used for 1-2 mins to homogenise the fruit. The extract was stirred for 20 mins, left to stand for 20 mins then centrifuged at 38,700×g for 20 mins (all performed at 4° C.). The supernatant was divided into 1 ml aliquots for the subsequent assays and frozen at −20° C.

Exogalactanase Assay

Exogalactanase activity was measured by a linked assay consisting of two steps. (1) Galactan was prepared as described [Methods in Carbohydrate Chemistry Volume 5 (pp 132-134] and incubated with extract in the presence of buffer. (2) D-galactose released in (1) was quantified by incubating with NAD and β-D-galactose dehydrogenase as described [Kurz and Wallenfels, 1974. Methods of enzymic analysis, 1279-1282. ed. Vedag Chemie, Weinheim].

1. The following components were mixed and incubated overnight at 30° C. (in duplicate):

| | | |
|---|---|---|
| Test: | 30 μl | 10 mg/ml Lupin Galactan |
| | 15 μl | 1M Na Acetate, pH 5.0 |
| | 30 μl | extract |
| Control: | 30 μl | H₂O |
| | 15 μl | 1M Na Acetate, pH 5.0 |
| | 30 μl | extract |
| Substrate Control: | 30 μl | 10 mg/ml Lupin Galactan |
| | 15 μl | 1M Na Acetate, pH 5.0 |
| | 30 μl | H₂O |

The reaction was stopped by incubating in a boiling water bath for 2 mins.

2. To 64 μl of each incubated sample (above step 1) the following were added;

64 μl Galactose Dehydrogenase [2.5 U/ml]
905 μl 0.1 MTris/HCl pH8.6

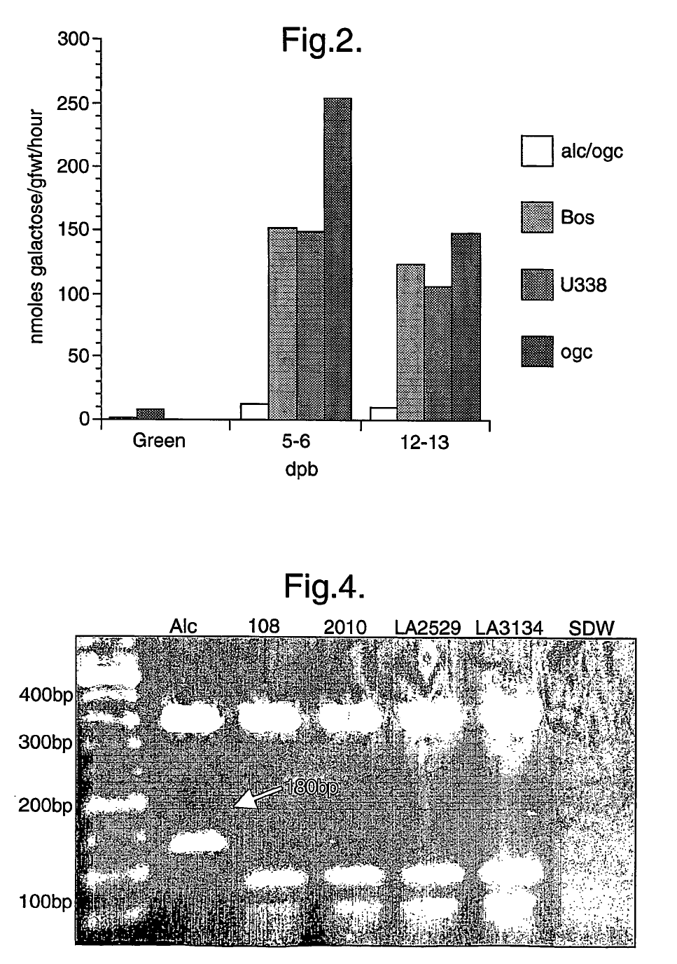

O.D. readings were taken at 340 nm, following which 32 μl, 12.5 mg/ml NAD was added. This was incubated at room temperature for 1 hour and a further reading at 340 nm was recorded (it was assumed that for each mole of galactose released, one mole of NADH is formed). Test ΔOD₃₄₀ (minus control and substrate control ΔODs) was converted to nmol gal/g fwt/hr using a galactose standard curve. The results are set out in FIG. 2.

### Example 4

### Polygalacturonase Activity

Polygalacturonase activity of four types of tomato was measured at three stages of maturity: 5-6 days post breaker, and 12-13 days post breaker and 19-20 days post breaker. The four types of tomatoes as in example 3 were analysed.

Polygalacturonase activity was measured using the PAHBAH method [Lever, M (1972) A new reaction for colorimetric determination of carbohydrates. Anal. Biochem. 47:273-279].

Materials: Solutions

Assay buffer stock: 50 mM sodium acetate buffer, pH 4.0 with 0.2M NaCl.

Substrate: Sigma polygalacturonic acid (PGA), 0.4% stock in water (fresh)

Standard: Sigma D-galacturonic acid, 50 mg/100 ml stock (fresh)

Enzyme extract: Tomato extracts were prepared as described in Example 3 except that 2.5 volumes of buffer were used (in order to reduce the level of endogenous reducing sugars).

Megazyme fungal polygalacturonase (ammonium sulphate suspension) was used as a positive control. Enzyme was diluted 1 in 1,000 in assay buffer and stored at −20° C.

Prior to use the enzyme was diluted 1 in 25 in assay buffer stock (giving 1 in 25,000 final dilution) and 10-200 ul used per assay.

PAHBAH stock solution A: Slurry 10 g para-hydroxybenzoic acid hydrazide (Sigma) in 60 ml H₂O. Add 10 ml conc. HCl, mix and make up to 200 ml with water (pale yellow solution, may be stored in fridge for several weeks).

PAHBAH stock solution B: Dissolve 29.4 g trisodium citrate (0.05M) in 500 ml water.

Add 2.2 g anhydrous (2.9 g dihydrate) calcium chloride (0.01M), mix well. Add 40 g NaOH (0.5M), dissolve and make up to 2 litres with water (colourless solution, may be stored in fridge for several weeks).

Materials: Equipment

Boiling water bath or dry heating block.

Temperature controlled water bath (40° C.) or dry heating block.

UV spectrophotometer and cuvettes.

Teflon capped tubes (5 ml).

Method

1. 0.25 ml aliquots of 0.4% PGA were placed in teflon capped tubes.

2. 0.25 ml of enzyme extract was added (final concentrations are 0.2% PGA, in 25 mM Na Ac buffer pH 4.0 with 0.1M NaCl). A buffer only negative control, boiled diluted enzyme negative control and Megazyme PG positive control were included at this stage. Tubes were centrifuged briefly in a bench top microfuge (2,000 rpm) to ensure all the assay mixture was at the bottom of the tube. Assays were started in batches of up to 24.

3. Assays were incubated at 40° C. for 1 hour (start of incubation equals T0).

4. After 1 hour incubation time, 5 ml of PAHBAH C (1 part of PAHBAH A to 9 parts of PAHBAH B, mixed well and kept on ice) was added to each assay and immediately incubated at 100° C. for 6 minutes. For T0 controls, 5 ml PAHBAH C was added to 0.25 ml of PGA, followed by 0.25 ml of appropriate enzyme dilution.

5. Samples were cooled under running water.

6. A standard curve was made (in duplicate) using galacturonic acid (0.025, 0.05, 0.1, 0.2, 0.3, 0.4 and 0.5 ml of Gal A Stock (50 mg/100 ml) per ml to give 59, 117, 235, 470, 705, 940 and 1175 nmoles GalA/0.5 ml standards). 5 mls of PAHBAH C was added, incubated at 100° C. for 6 minutes then cooled under running water.

| Gal A Stock (50 mg/100 ml) | | |
|---|---|---|
| per ml | WATER per ml | Nmoles Gal A/0.5 ml |
| 0.5 | 0 | 1175 |
| 0.4 | 0.1 | 940 |
| 0.3 | 0.2 | 705 |
| 0.2 | 0.3 | 470 |
| 0.1 | 0.4 | 235 |
| 0.05 | 0.45 | 117 |
| 0.025 | 0.475 | 59 |
| 0 | 0.5 | 0 |

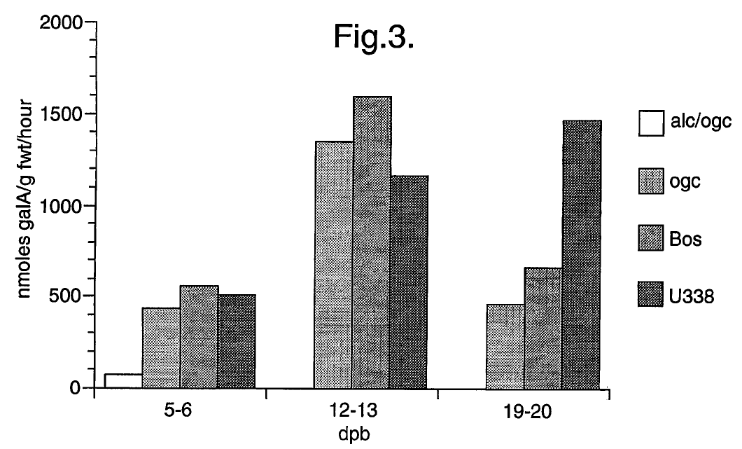

7. OD readings were taken at 410 nm and the change in OD₄₁₀ over one hour (T60-T0) determined. These values were multiplied by an OD to nmoles galA conversion factor (from standard curve of OD₄₁₀ vs. nmoles Gal A) and then by 10 (0.1 g tissue/assay extract) to give a final value unit of nmoles galA produced/hour/g fresh weight. The results are set out in FIG. 3.

### Example 5

### Molecular Characterisation of Ripening-Inhibited Mutant

Definitive identification of ripening-inhibited mutants is difficult as many accessions have been assigned to a particular nomenclature (e.g. nor, rin, Nr, alc) based on their ripening-inhibited phenotype. Recently, gene compositions involved in ripening-inhibition have been reported for rin (WO01/14315) and nor (WO01/14561). Knowledge of the gene composition permits the development of a DNA-based molecular screen that defines the particular ripening-inhibited mutant.

A ripening mutant (thought to be alc, and as used in the other examples herein) is characterised by the fact that it yields fragments of approx 393 bp, 180 bp and 35 bp following amplification of a region of genomic DNA using primers N12 and N13 and restriction of this amplification product with Taq1. By contrast, normal ripening and some ripening-inhibited mutants (e.g. nor) yield fragments of approx 393 bp, 120 bp, 60 bp and 35 bp. The presence of the 180 bp fragment following this analysis therefore defines this ripening-inhibited fruit (thought to be alc). Interestingly, the 180 bp fragment is absent in the Tomato Genetic Resource Center (TGRC) alc accessions LA2529 and LA3134. Molecular screening for the presence of this 180 bp fragment was a described below.

Seeds from the ripening-inhibited mutant (used in the present examples, thought to be alc), TGRC alc accessions LA2529 and LA3134, inbred line 108 (internal breeding line with conventional ripening and colour) and hybrid line 2010 (internal breeding line with conventional ripening and colour) were germinated in compost (John Innes No 2) and maintained in a glasshouse (day/night temperatures 23° C./18° C.; 16 hr photoperiod). Leaf material was collected from plants ˜3 week post-germination and immediately frozen in liquid nitrogen before placing at −80° C. prior to DNA extraction. Genomic DNA was extracted from ˜100 mgFwt frozen leaf material using QIAGEN DNeasy plant DNA extraction kit according to manufacturers instructions with the inclusion of the optional 5 min centrifugation step to remove cell and protein debris from the lysate. Genomic DNA was eluted from the QIAGEN column in 200 μl elution buffer (10 mM Tris.CL, pH8.0). Each DNA preparation was then further diluted (4-fold) prior to use as a target for PCR amplification.

For amplification, the oligonucleotide primers N12 and N13 were synthesised by Sigma-Genosys and were provided lyophilised following a desalt purification. Both primers were resuspended in 10 mM Tris.Cl pH7.5 to a final concentration of 100 pmol μl⁻¹.

The amplification reaction mix comprised 3 μl genomic DNA, 0.15 μl primer N12 [5′-atcccaacatatcatgcaaatcatctat-3′], 0.15 μl primer N13 [5′-taatgtactttaaccaggggcggctcta-3′], 15 μl JumpStart™ REDTaq™ ReadyMix™ (Sigma-Aldrich), and 11.7 μl sterile distilled water. Reaction mixtures were thermocycled at 94° C.-7 min, 35 cycles of [94° C.-45 sec, 53° C.-30 sec, 72° C.-90 sec] followed by a final extension step of 72° C. for 10 min. Following amplification, reaction products were restricted by the addition of 2 μl Taq1 directly to the amplification reaction mixture and further incubation at 65° C. for 1 hour. Following Taq1 restriction of amplification products, fragments were separated by electrophoresis through a 1.5% (w/v) agarose gel and visualised using ethidium bromide and UV transillumination (see FIG. 4).

The photograph of the fragments following separation by agarose gel electrophoresis clearly shows the presence of the 180 bp fragment following N12-N13 amplification and Taq1 restriction of genomic DNA from the ripening-inhibited mutant thought to be alc.

1. Tomato paste having an increased consistency such that when measured at an insoluble solids interval of 2.5-3.6% at 12° Brix:
(Bostwick value)<10.5−2.3822×(percentage of insoluble solids).

2. Tomato paste according to claim 1, such that when measured at insoluble solids interval of 2.5-3.6% at 12° Brix:
(Bostwick value)<10.0−2.3822×(percentage of insoluble solids).

3. Tomato paste according to claim 2, such that when measured at an insoluble solids interval of 2.5-3.6% at 12° Brix:
(Bostwick value)<9.5−2.3822×(percentage of insoluble solids).

4. Tomato paste according to claim 1, wherein the paste is obtained by a hot break process, and optionally followed by concentration.

5. Tomato paste according to claim 1, having a red, yellow, pink, or orange color at 8.5° Brix.

6. Processed tomato product, comprising at least 10% (pref. 20%, more pref. 50%) tomatoes which are homozygous for rin, homozygous for nor, homozygous for Nr, homozygous for alc, heterozygous for combinations of two of the rin, nor, Nr or alc genes, or combinations thereof, whereby the term “processed tomato product” is defined as a product that comprises tomatoes which are subjected to a concentration step.

7. Product according to claim 6 comprising tomatoes which are homozygous for at least two genes of rin, nor, Nr, or alc.

8. Product according to claim 6 having a red, yellow, pink, or orange color at 8.5 Brix.

9. Product according to claim 6 wherein said tomatoes further comprise at least one color-enhancing gene.

10. Product according to claim 9 wherein said color enhancing genes are selected from the group consisting of old gold crimson (ogc), high pigment (hp), dark green (dg), intense pigment (Ip), as well as color enhancing transgenic genes.

11. Product according to claim 6, wherein the processed tomato product is in the form of tomato pastes, tomato sauces, tomato juices, tomato concentrates, tomato passatas, salsa, barbecue sauce, pizza sauce, spaghetti sauce, tomato fritto, ketchup (catsup), soup, pulp, dices or other form.

12. Process for preparing a tomato product, the product having a red, yellow, pink, or orange color and wherein at least 10% (pref. 20%, more pref. 50%) of the tomatoes to be processed have a level of polygalacturonase of less than 200 (preferably less than 100, more pref. less than 50) μmoles GalA/ml/hour, and wherein said tomatoes to be processed have a level of exogalactanase of less than 70 (preferably less than 35) nmoles galactose/g fwt/hour.

13. Process according to claim 12, wherein at least 10% (pref. 20%, more pref. 50%) of the tomatoes to be processed are homozygous for rin, homozygous for nor, homozygous for Nr, homozygous for alc, heterozygous for combinations of two of the rin, nor, Nr or alc genes, or combinations thereof.

14. Process according to claim 12, wherein other ripening-inhibiting genes than alc, rin, nor, Nr, are present in the tomato in such a genotypic form that they inhibit ripening.

15. Process according to claim 12, wherein said tomatoes further comprise at least one color enhancing gene.

16. Process according to claim 15, wherein said color enhancing genes are selected from the group consisting of old gold crimson (ogc), high pigment (hp), dark green (dg), intense pigment (Ip), as well as color enhancing transgenic genes.

17. Process according to claim 12, wherein the process comprises the steps of:
heating tomatoes to a temperature of 60-120° C.
comminuting or dicing said tomatoes
in any given order.

18. Red, orange, yellow or pink tomato showing a 180 bp fragment following PCR amplification using oligonucleotides 5′-atcccaacatatcatgcaaatcatctat-3′ and 5′-taatgtactttaaccaggggcggctcta-3′ and Taq1 restriction of genomic DNA of said tomato.

19. Food product containing at least 10% wt of the tomato according to claim 18.

20. Tomato paste, tomato pulp, tomato dices comprising at least 10% wt of the tomato according to claim 18.

21. Process according to claim 12, wherein the tomatoes comprise at least 10% wt of tomatoes.
